(19) United States
(12) Patent Application Publication
(10) Pub. No.: US 2005/0219720 A1
(43) Pub. Date: Oct. 6, 2005

(54) Projection lens unit

(76) Inventors: Fumitoshi Yura, Sano-shi (JP); Kumajiro Sekine, Sano-shi (JP)

Correspondence Address: LORUSSO, LOUD & KELLY, 3137 Mount Vernon Avenue, Alexandria, VA, 22305, US

(21) Appl. No.: 11/087,675

(22) Filed: Mar. 24, 2005

(30) Foreign Application Priority Data
Mar. 31, 2004 (JP) 106119

(51) Int. Cl. G02B 15/14; G02B 7/02

(52) U.S. Cl. 359/820

(57) ABSTRACT

Sealing is securely performed according to a change caused by thermal expansion and contraction, dust and the like are prevented from intruding, and degradation of image quality is protected. A single lens 11 or the plural lenses 11 are mounted into a cylinder portion in a projection lens unit, and the projection lens unit magnifies and projects an image and the like on a light source side onto a screen. The projection lens unit includes an O-ring 17 which seals a gap by permitting a change in gap generated when the cylinder portion is expanded and contracted according to temperature change caused by heat of the light source. The cylinder portion includes an inner lens-barrel 12 which supports the lens 11 and an outer lens-barrel 13 which slidably supports the inner lens-barrel 12, and the cylinder portion also includes a coupler unit 4 connecting the outer lens-barrel 13 onto the light source side. The O-rings 17 are provided in the gap between the inner lens-barrel 12 and the outer lens-barrel 13 and the gap between the outer lens-barrel 13 and the coupler unit 4, and the O-rings 17 seal the cylinder portion by permitting the change in gap caused by temperature change.

### CROSS-REFERENCE TO RELATED APPLICATION

This application claims, under 35 USC 119, priority of Japanese Application No. 2004-106119 filed Mar. 31, 2004.

### BACKGROUND OF THE INVENTION

1. Field of the Invention

The present invention relates to a projection lens unit suitable for a rear projection type image display apparatus, particularly to the projection lens unit which eliminates intrusion of dust and the like associated with expansion and contraction caused by heat generation of a light source.

2. Description of the Related Art

Recently, high brightness and high contrast have been demanded in projection displays. Like a high-definition TV (HDTV) image, as resolution of an image is increased, a heating value of the light source is increase in order to realize high-brightness image in the so-called rear projection TV installed in the home. For example, sometimes a temperature of a fluorescent tube surface of a CRT projection tube is increased up to about 90° C. as the heating value of the light source is increased. In this case, the fluorescent tube surface of the CRT projection tube returns to a room temperature when the power is turned off, so that temperature change of about 70° C. may occur.

When such large temperature change occurs, the thermal expansion and contraction are generated in respective components, and an air flow is generated between the inside and the outside of a lens-barrel. A flow of dust and the like occurs associated with the air flow. When the rear projection TV is used for a long time, the respective gaps between the components are repeatedly widened and narrowed by repetitions of the thermal expansion and contraction many times, and the air flows repeatedly between the inside and the outside of the lens-barrel.

When the gaps between the respective components are widened and narrowed by repetitions of the thermal expansion and contraction many times during the long use to cause the air to flow, sometimes the dust and the like in the home intrude into the inside lens-barrel from the gaps of the lens-barrel. When the dust and the like intrude, the dust and the like adhere to a lens surface, which adversely affects the projected image. For example, the contrast is remarkably decreased or the brightness is decreased, which degrades the image quality.

In this case, in a lens facing toward the outside, there in no problem because cleaning is easy to perform. However, in the lens facing toward the inside, there is generated the problem because the cleaning is difficult to perform.

Further, in the rear projection TV adopting DMD (Digital Micromirror Device) which is of a reflection type image display device is used, or in the rear projection TV using a transmission type LCD and a reflection type LCOS (Liquid Crystal on Silicon) which are of applications of liquid crystal displays, the temperature is increased to about 60° C. in the insides of optical engines. Therefore, similarly there is the problem that the dust and the like intrude in the inside by the thermal expansion and contraction to degrade the image quality.

### SUMMARY OF THE INVENTION

In view of the foregoing, an object of the invention is to provide a projection lens unit which can prevent intrusion of the dust and the like caused by the thermal expansion and contraction.

In order to solve the problem, the projection lens unit according to the invention in which a single lens or a plurality of lenses are mounted into a cylinder portion, the projection lens unit magnifying and projecting an image and the like on a light source side onto a screen, the projection lens unit includes a sealing member which seals a gap by permitting a change in gap when the cylinder portion is expanded and contracted according to temperature change caused by heat of the light source.

According to the above configuration, when the cylinder portion is expanded or contracted by the heat of the light source to widen or narrow the gap, the sealing member seals the gap by permitting the change in gap.

Another projection lens unit according to the invention which magnifies and projects an image and the like on a light source side onto a screen, the projection lens unit includes an optical path folding unit mounted onto the light source side, the optical path folding unit folding an optical path with a built-in reflecting mirror; and a fore-group lens-barrel integrally mounted to the optical path folding unit, wherein a reflecting mirror mounting portion of the optical path folding unit and a fitting portion between the optical path folding unit and the fore-group lens-barrel include seal members which seal a gap by permitting a change in gap caused by temperature change.

According to the above configuration, even if the gap is widened or narrowed by the thermal expansion and contraction in the reflecting mirror mounting portion, the sealing member always seals the gap to prevent the intrusion of the dust and the like by providing the sealing member in the reflecting mirror mounting portion of the optical path folding unit. Similarly, for the fitting portion between the optical path folding unit and the fore-group lens-barrel, even if the gap is widened or narrowed by the thermal expansion and contraction in the fitting portion, the sealing member always seals the gap to prevent the intrusion of the dust and the like by providing the sealing member.

As described above, the sealing member seals the gap to prevent the intrusion of the dust and the like, so that the high-resolution, high-brightness, high-contrast image can be provided for a long time.

### BRIEF DESCRIPTION OF THE DRAWINGS

FIG. 1 is a sectional side view showing a projection lens unit according to a first embodiment of the invention;

FIG. 2 is an exploded perspective view showing the projection lens unit according to the first embodiment of the invention when viewed from a screen side;

FIG. 3 is an exploded perspective view showing the projection lens unit according to the first embodiment of the invention when viewed from a CRT projection tube side;

FIG. 4 is an exploded perspective view showing the projection lens unit according to a second embodiment of the invention when viewed from the screen side; and

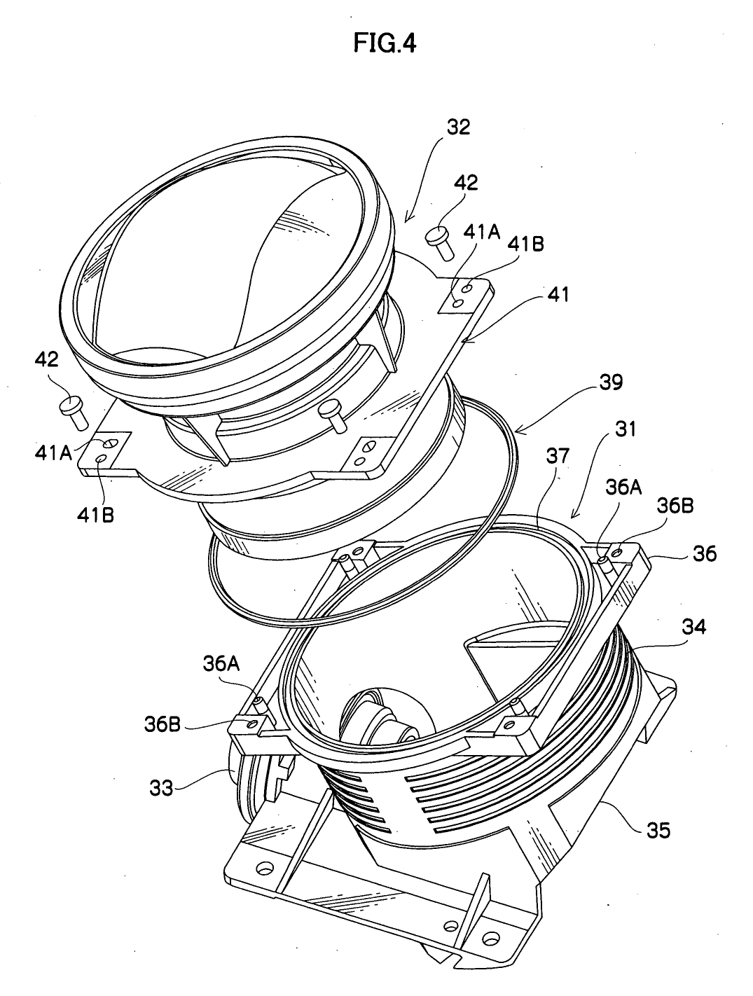

FIG. 5 is an exploded perspective view showing a projection lens unit according to the second embodiment of the invention when viewed from a mirror side.

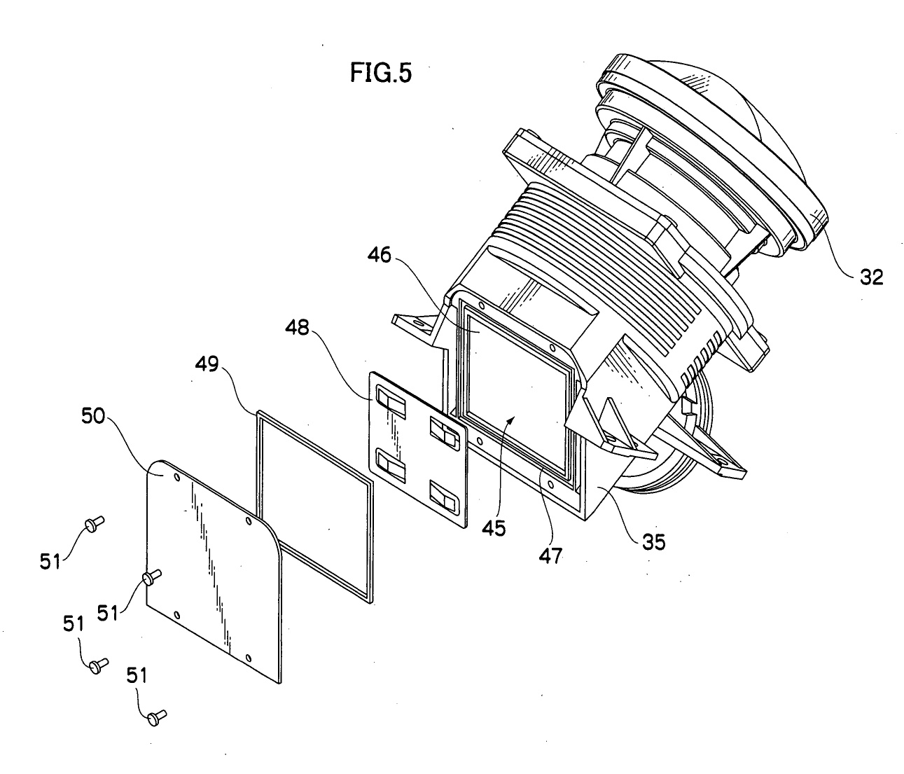

### DETAILED DESCRIPTION OF THE PREFERRED EMBODIMENTS

First Embodiment

Referring now to the accompanying drawings, a projection lens unit according to a first embodiment of the invention will be described in detail.

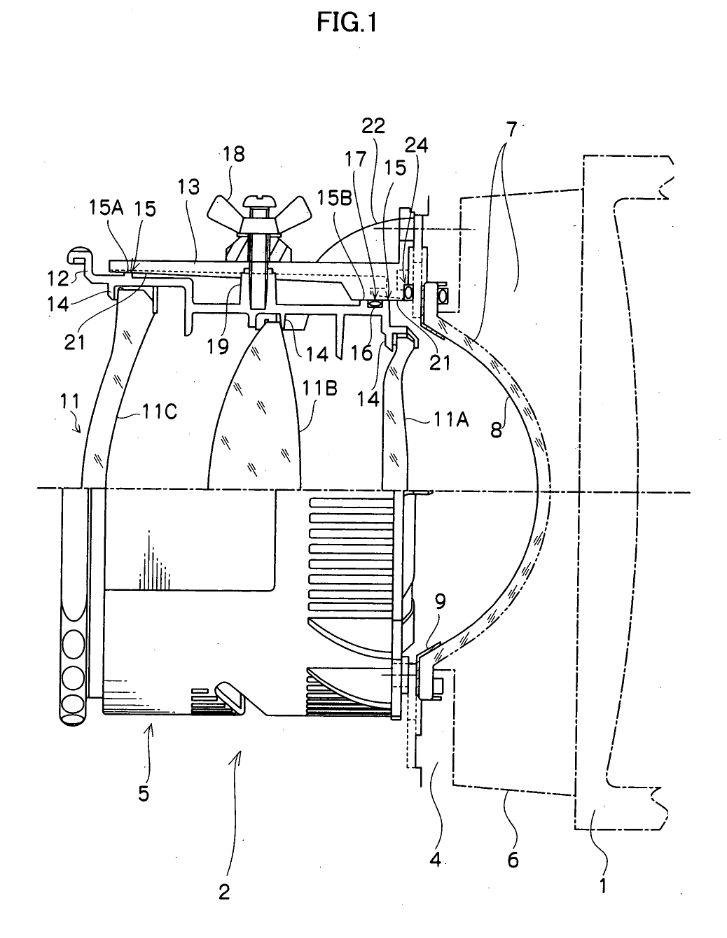

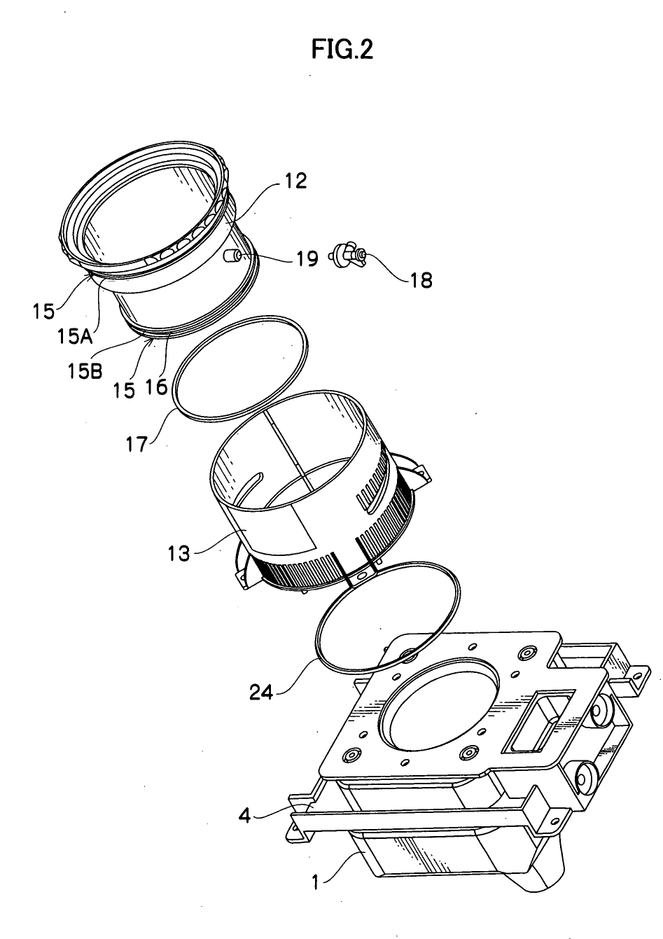

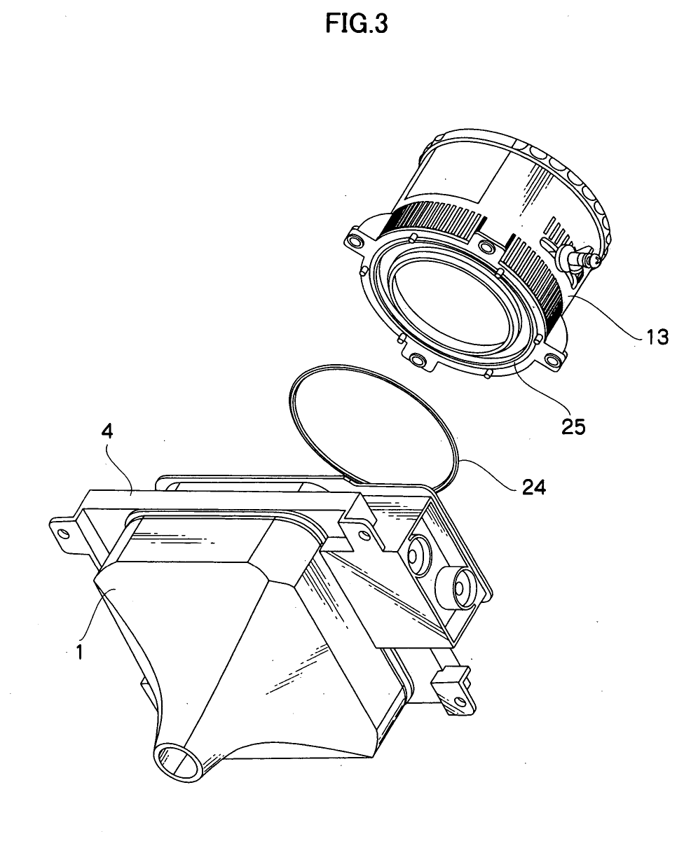

FIG. 1 is a sectional side view showing the projection lens unit, FIG. 2 is an exploded perspective view showing the projection lens unit when viewed from a lens side, and FIG. 3 is an exploded perspective view showing the projection lens unit when viewed from a CRT projection tube side.

In the case of a projector and the like, an image produced on the CRT projection tube 1 side is magnified by a projection lens unit 2 and projected onto a screen (not shown).

The CRT projection tube 1 is a device to project the produced image. A front face (left-side face in FIG. 1) of the CRT projection tube 1 is formed in a flat shape, and the later-mentioned coupler unit 4 is mounted to the front face.

The projection lens unit 2 is a member for projecting the image produced on the CRT projection tube 1 side onto the screen while focusing on the screen. The projection lens unit 2 includes the coupler unit 4 and a lens unit main body 5.

The coupler unit 4 is a member for fixing the lens unit main body 5 to the CRT projection tube 1. The coupler unit 4 includes an outer frame 6 and a field curvature correction unit 7. The outer frame 6 is formed in a square thick plate, and one end (right side in FIG. 1) of the outer frame 6 comes into contact with the front face of the CRT projection tube 1.

The field curvature correction unit 7 includes a concave element 8 and cooling fluid. A light shield plate 9 is mounted in a peripheral portion of the concave element 8. The light shield plate 9 permits only image light from the CRT projection tube 1 (image light which appears on an inverse R plane of the CRT projection tube 1) to pass through, and the light shield plate 9 removes unnecessary light which exists in the outside the image light.

The lens unit main body 5 is a member for projecting the image produced on the CRT projection tube 1 side onto the screen so as to directly control the light from the CRT projection tube 1. The lens unit main body 5 includes a lens 11, an inner lens-barrel 12, and an outer lens-barrel 13.

The lens 11 is formed by a single concave lens or a single convex lens or by combining the plural concave lenses and convex lenses according to design. In this case, the lenses 11 are formed by combining three lenses of an inner lens 11A, an intermediate lens 11B, and an outer lens 11C.

An inner lens-barrel 12 is a member for accurately supporting the respective lenses 11 in agreement with set positions. Lens supporting portions 14 are provided every design intervals in the inside surface of the inner lens-barrel 12. The lens supporting portions 14 accurately support the lenses 11 at the design positions respectively. A slide portion 15 is provided in an outer periphery of the inner lens-barrel 12. The slide portion 15 slides to an outer lens-barrel 13 while supported by the outer lens-barrel 13, when the inner lens-barrel 12 appears from and disappears into the outer lens-barrel 13. The inner lens-barrel 12 is supported at the slide portion 15 by the outer lens-barrel 13. The slide portion 15 includes a leading-end slide portion 15A provided on the leading-end side of the inner lens-barrel 12 and a base-end slide portion 15B provided on the base-end side of the inner lens-barrel 12. In the base-end slide portion 15B, a ring groove 16 is provided at the central portion of a surface which slides to the inner surface of the outer lens-barrel 13. An O-ring 17 is provided in the ring groove 16. The O-ring 17 is a sealing member which seals between the inner lens-barrel 12 and the outer lens-barrel 13 by permitting a change in gap generated between the inner lens-barrel 12 and the outer lens-barrel 13 when the inner lens-barrel 12 and the outer lens-barrel 13 are thermally expanded and contracted according to temperature change caused by heat of a light source. The O-ring 17 elastically engages an engaging surface of the outer lens-barrel 13 while fitted in the ring groove 16, and the O-ring 17 seals the gap between the inner lens-barrel 12 and the outer lens-barrel 13. The O-ring 17 is made of a material having low temperature dependence. Specifically, the O-ring 17 is made of a synthetic resin material which can hold elasticity constant in a range from a room temperature to a temperature as high as about 90°. For example, soft silicone rubber can be used as the synthetic resin material. Therefore, when the gap between the inner lens-barrel 12 and the outer lens-barrel 13 is widened or narrowed by the thermal expansion and contraction due to heat of a light source, the O-ring 17 is elastically deformed to seal the gap by following the change in gap.

The inner lens-barrel 12 is fixed to the outer lens-barrel 13 with a focus lock screw 18. The inner lens-barrel 12 can be detached from the outer lens-barrel 13 by unscrewing the focus lock screw 18, and the inner lens-barrel 12 can be exchanged to the differently designed inner lens-barrels 12. The differently designed lens unit main bodies 5 can be mounted to the CRT projection tube 1 by exchanging the various inner lens-barrels 12 in the same outer lens-barrel 13. A nut portion 19 into which the focus lock screw 18 is screwed is provided in the outer periphery of the inner lens-barrel 12 while extending to a position where the nut portion 19 is in contact with the inner surface of the outer lens-barrel 13. The inner lens-barrel 12 is supported only by the outer lens-barrel 13, and the inner lens-barrel 12 is not in contact with the coupler unit 4.

The outer lens-barrel 13 is a member for housing and slidably supporting the inner lens-barrel 12, while fixed to the coupler unit 4. An inner lens-barrel support portion 21 which slides to the slide portion 15 of the inner lens-barrel 12 is provided in the inside surface of the outer lens-barrel 13. Therefore, the outer lens-barrel 13 supports the inner lens-barrel 12 to permit the inner lens-barrel 12 to appear and disappear. The outer lens-barrel 13 is fixed to the coupler unit 4 through a leg portion 22.

An O-ring 24 is provided in the base-end portion (end portion on the coupler unit 4 side) of the outer lens-barrel 13. A ring groove 25 is provided in a base-end surface of the outer lens-barrel 13, and the O-ring 24 is mounted to the ring groove 25. The O-ring 24 elastically engages the engaging surface of the coupler unit 4 while fitted in the ring groove 25, and the O-ring 24 seals the gap between the outer lens-barrel 13 and the coupler unit 4. The O-ring 24 is made of the material having the low temperature dependence. Specifically, the O-ring 24 is made of the synthetic resin material which can hold the elasticity constant in the range from a room temperature to a temperature as high as about 90°. Therefore, when the gap between the outer lens-barrel 13 and the coupler unit 4 is widened or narrowed by the thermal expansion and contraction by heat of a light source, the O-ring 24 is elastically deformed to seal the gap by following the change in gap.

Operation

In the projection lens unit 2 having the above configuration, the O-rings 17 and 24 are operated as follows.

When the power is turned on, the image light produced on the CRT projection tube 1 side is projected onto the screen through the projection lens unit 2. At this point, heat generation occurs in a surface of the CRT projection tube 1 by the power input to gradually heat an environment. Accordingly, the inner lens-barrel 12, the outer lens-barrel 13, and the coupler unit 4 are heated, respectively, and thermally expanded according to the respective shapes and the like. When the power is turned off, the CRT projection tube 1 dissipates the heat, and the CRT projection tube 1 is cooled to the room temperature to be contracted. Accordingly, the gap is widened or narrowed between the inner lens-barrel 12 and the outer lens-barrel 13 by shifting to each other, and the gap is widened or narrowed between the outer lens-barrel 13 and the coupler unit 4 by shifting to each other.

Therefore, the O-rings 17 and 24 which have the low temperature dependence and high elasticity follow the change caused by the thermal expansion and contraction, which allows the O-rings 17 and 24 to seal respectively between the inner lens-barrel 12 and the outer lens-barrel 13 and between the outer lens-barrel 13 and the coupler unit 4 to prevent dust and the like from intruding into the inner lens-barrel 12.

Effect

As described above, the O-rings 17 and 24 follow the change caused by the thermal expansion and contraction and seal respectively between the inner lens-barrel 12 and the outer lens-barrel 13 and between the outer lens-barrel 13 and the coupler unit 4 to prevent the dust and the like from intruding into the inner lens-barrel 12. Therefore, the dust and the like do not adhere to the surfaces of the respective lenses 11 in the inner lens-barrel 12, and the image quality can be prevented from degrading.

As a result, the image quality can be maintained at a high level even if the projection lens unit 2 is used for a long time, and the reliability of the projection lens unit 2 can further be improved.

Second Embodiment

Then, a projection lens unit according to a second embodiment of the invention will be described. The projection lens unit according to the second embodiment includes an optical path folding unit which folds an optical path.

The projection lens unit according to the second embodiment includes an optical path folding unit 31 and a fore-group lens-barrel 32.

The optical path folding unit 31 includes a rear-group lens-barrel 33, a fore-group lens-barrel-side cylinder portion 34, and a reflecting mirror mounting portion 35. A light-source-side unit into which an image display device such as a micro display is incorporated is mounted to the rear-group lens-barrel 33. The rear-group lens-barrel 33 and the fore-group lens-barrel-side cylinder portion 34 are arranged at a set angle (for example, 66°)

The fore-group lens-barrel 32 is mounted to the fore-group lens-barrel-side cylinder portion 34. The fore-group lens-barrel-side cylinder portion 34 is formed in a cylindrical shape, and a flange 36 and a ring groove 37 are provided in the end portion on the fore-group lens-barrel 32 side.

The flange 36 is a member for fixing the fore-group lens-barrel 32. The flange 36 is formed in a square shape as a whole. Positioning protrusions 36A and fixing holes 36B are made at four corners of the flange 36 respectively. An O-ring 39 is fitted in the ring groove 37. The ring groove 37 is formed in a ring shape through a perimeter of the end portion on the fore-group lens-barrel 32 side of the fore-group lens-barrel-side cylinder portion 34.

The O-ring 39 is a sealing member which seals between the optical path folding unit 31 and the fore-group lens-barrel 32 by permitting the change in gap generated between the optical path folding unit 31 and the fore-group lens-barrel 32 when the optical path folding unit 31 and the fore-group lens-barrel 32 are thermally expanded and contracted, respectively, according to temperature change caused by the heat of the light source. The O-ring 39 elastically engages the engaging surface of the fore-group lens-barrel 32 while fitted in the ring groove 37, and the O-ring 39 seals the gap between the optical path folding unit 31 and the fore-group lens-barrel 32. As with the O-rings 17 and 24 of the first embodiment, the O-ring 39 is made of the material having the low temperature dependence. Specifically, the O-ring 39 is made of the synthetic resin material which can hold the elasticity constant in the range from the room temperature to the temperature as high as about 90°. Therefore, when the gap between the optical path folding unit 31 and the fore-group lens-barrel 32 is widened or narrowed by the thermal expansion and contraction due to the heat of the light source, the O-ring 39 is elastically deformed to seal the gap by following the change in gap.

In the fore-group lens-barrel 32, a flange 41 is provided at a position opposite the flange 36 located on the optical path folding unit 31 side. The flange 41 is formed in a square shape by matching the flange 36. Fitting holes 41A and 42B are made in the four corners of the flange 41 respectively. The positioning protrusion 36A of the flange 36 and a screw 42 are fitted in the fitting holes 41A and 41B respectively. The optical path folding unit 31 and the fore-group lens-barrel 32 are fixed to each other while matching with each other by fitting the positioning protrusion 35A and the screw 42 in the fitting holes 41A and 41B respectively.

A mirror 46 which folds the optical path is mounted to the reflecting mirror mounting portion 35. A square opening 45 is provided in the reflecting mirror mounting portion 35, and the mirror 46 is mounted to the opening 45. A square ring groove 47 is provided in a peripheral portion of the opening 45, and a square O-ring 49 is mounted in the square ring groove 47. As with the O-ring 39, the O-ring 49 is made of the material having the low temperature dependence and high elasticity.

The mirror 46 and the O-ring 49 are fixed by a plate spring 48 and a mirror cover 50. The plate spring 48 is a member elastically for supporting the mirror 46 so that the plane of the mirror is not deformed. In the plate spring 48, spring portions are formed by cutting four points in a plate substrate. In the plate spring 48, the four spring portions support the mirror 46 by elastically coming into contact with the mirror 46. The plate spring 48 and the O-ring 49 are covered with the mirror cover 50, and the mirror cover 50 is fixed to the opening 45 at the outside of the O-ring 49 with screws 51.

According to the above configuration, when the optical path folding unit 31, the fore-group lens-barrel 32, the plate spring 48, and the mirror cover 50, respectively, are thermally expanded and contracted by the heat of the light source, the gaps between the optical path folding unit 31 and the fore-group lens-barrel 32 and the gap between the plate spring 48 and the mirror cover 50 are widened or narrowed. However, as with the first embodiment, the O-rings 39 and 49 always seal the gaps to prevent the dust and the like from intruding. As a result, high-resolution image can be provided for a long time, and the reliability is improved.

Modified Example

Although examples of the projection lens unit are described in the first and second embodiments, the invention is not limited to the first and second embodiments. The invention can be applied to any projection lens unit for which the prevention of the intrusion of the dust and the like is required, and the same operation and effect as the first and second embodiments can be realized.

1. A projection lens unit in which a single lens or a plurality of lenses are mounted into a cylinder portion, the projection lens unit magnifying and projecting an image on a light source side onto a screen,
the projection lens unit comprising a sealing member which seals a gap by permitting a change in gap when the cylinder portion is expanded and contracted according to temperature change caused by heat of the light source.

2. A projection lens unit according to claim 1, wherein the cylinder portion comprises a coupler unit which has an inner lens-barrel supporting the lenses and an outer lens-barrel slidably supporting the inner lens-barrel while connecting the outer lens-barrel onto the light source side, and
the sealing members are provided in the gap between the inner lens-barrel and the outer lens-barrel and the gap between the outer lens-barrel and the coupler unit respectively, and the cylinder portion is sealed by permitting each change in gap according to the temperature change.

3. A projection lens unit according to claim 2, wherein the sealing member comprises an O-ring which seals the gap by permitting the change in gap caused by the thermal expansion and contraction, the O-ring being provided between a slide portion of an outer periphery of the inner lens-barrel sliding to the outer lens-barrel and an inside surface of the outer lens-barrel; and an O-ring which seals the gap by permitting the change in gap caused by the thermal expansion and contraction, the O-ring being provided between a base-end surface of the outer lens-barrel and a contact surface of the coupler unit.

4. A projection lens unit according to claim 3, wherein the O-ring is made of a material which has low temperature dependence, elasticity being able to be substantially held constant for the temperature change, and the O-ring seals the gap by following the change in gap.

5. A projection lens unit which magnifies and projects an image on a light source side onto a screen, the projection lens unit comprising:
an optical path folding unit mounted onto the light source side, the optical path folding unit folding an optical path with a built-in reflecting mirror; and
a fore-group lens-barrel integrally mounted to the optical path folding unit,
wherein a reflecting mirror mounting portion of the optical path folding unit and a fitting portion between the optical path folding unit and the fore-group lens-barrel include seal members which seal a gap by permitting a change in gap caused by temperature change.

6. A projection lens unit according to claim 5, wherein the seal member is made of an O-ring which has low temperature dependence, elasticity being able to be substantially held constant for the temperature change, and the seal member seals the gap by following the change in gap.
